(19) United States
(12) Patent Application Publication
(10) Pub. No.: US 2010/0322189 A1
(43) Pub. Date: Dec. 23, 2010

(54) SUPPORTING OPTIMIZED HANDOVER OF A USER EQUIPMENT BETWEEN DISSIMILAR NETWORKS

(75) Inventor: Zu Qiang, Kirkland (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET L M ERICSSON (PUBL), Stockholm (SE)

(21) Appl. No.: 12/785,189

(22) Filed: May 21, 2010

Related U.S. Application Data
(60) Provisional application No. 61/218,650, filed on Jun. 19, 2009.

(51) Int. Cl. H04W 36/16

(52) U.S. Cl. 370/331

(57) ABSTRACT

A method and a mobility management entity (MME) are provided for supporting optimized handover of a user equipment (UE) session between radio access networks (RAN) that may offer different radio access technologies. The MME provides mobility management for the UE session. To support eventual handover tunneling between a first radio network, in which the session is set up, and a second radio network, in which the session may continue, an uplink generic routing encapsulation (GRE) key is reserved upon session set up. The MME requests a packet data gateway (PGW) to allocate and reserve the uplink GRE key, early on in the UE session setup process. Upon handover, the MME provides the reserved key to the second radio network.

### PRIORITY STATEMENT UNDER 35 U.S.C. S.119(e) & 37 C.F.R. S.1.78

This non-provisional patent application claims priority based upon the prior U.S. provisional patent application entitled “GRE KEY RESERVATION AT OPTIMIZED HANDOFF FROM GTP TO PMIP”, application Ser. No. 61/218,650, filed on Jun. 19, 2009, in the name of Zu Qiang. The provisional patent application is incorporated herein by reference.

### TECHNICAL FIELD

The present invention relates generally to the field of communications and, more specifically, to a method and a node for supporting optimized handover of a user equipment between dissimilar networks.

### BACKGROUND

The 3^{rd} generation partnership project (3GPP) standardization committee has recognized the need to support interoperability of user terminals capable of receiving service from non-3GPP radio access technologies. Specifically, a user terminal may be both capable of accessing 3GPP networks as well as another radio access technology defined by the 3^{rd} generation partnership project 2 (3GPP2) standardization committee.

FIG. 1 (Prior Art) is a representation of an exemplary 3GPP network adapted to support a proxy mobile internet protocol. A 3GPP network 100, also called evolved packet system (EPS), comprises a user equipment (UE) 110, a first radio access network (RAN1) 120, a second radio access network (RAN2) 170, a mobility management entity (MME) 140, a serving gateway (SGW) 130, a packet gateway (PGW) 150, the PGW sometimes being called packet data network gateway (PDN GW), and a service network 160. The RAN1 120 comprises an access node (AN1) 122; the RAN2 170 also comprises an access node (AN2) 172. The 3GPP network 100 is much simplified for ease of illustration; the network 100 may comprise several gateways PGW and SGW, several RANs, and several MMEs, each RAN may comprise a plurality of access nodes and support a large number of UEs. The service network 160 may comprise various servers, routers, bridges, and the like. The 3GPP network 100 may comprise various other types of nodes, which are not shown because they are not relevant to the present description. The various shown nodes may be interconnected directly of through other elements (not shown) such as routers or bridges.

Various standard reference points are shown on FIG. 1. These reference points are defined in the 3GPP Technical Specification (TS) 23-401 V9.1.0 (2009-06), which is incorporated herein by reference in its entirety. The reference points shown on FIG. 1 are defined as follows:
Uu Radio protocols used between the UE and the RANs.
S1_U Reference point between 3GPP RAN and SGW for the per bearer user plane tunneling.
S5 Provides user plane tunneling and tunnel management between SGW and PGW.
S8 Variant of S5 for use when the SGW and the PGW belong to distinct operator networks.
S1_MME Reference point for the control plane protocol between a 3GPP RAN and MME.
S101 Registration and handover reference point between a non-3GPP RAN and the 3GPP network.
S11 Reference point between MME and SGW.
SGi Reference point between the PGW and the service network.

The network 100 may include 3GPP as well as non-3GPP system accesses. For example, the RAN1 120 may support a 3GPP radio access technology such as wideband code division multiple access (WCDMA), high speed packet access (HSPA), or evolved universal terrestrial radio access network (E-UTRAN), the latter being defined as a long term evolution (LTE) for 3GPP. Meanwhile the RAN2 170 may support code division multiple access 2000 (CDMA2000) or high rate packet data (HRPD), as defined by the 3GPP2. In the core (non-radio) network, proxy mobile internet protocol (PMIP) and general packet radio service (GPRS) tunneling protocol (GTP) can be used as mobility protocols.

The 3GPP network 100 uses an uplink generic routing encapsulation (GRE) key to identify connections within the PGW. It is to be noted that while GRE keys may be defined on uplink and downlink bases, the uplink GRE key is unique to the PGW, as opposed to the downlink GRE key which is only unique on a per SGW basis. The uplink GRE key is therefore used within the 3GPP network 100 to support setting of a PMIP tunnel for the UE 110.

When the UE 110 is attached at a GTP network, for instance by use of LTE access, it may handover to a PMIP based network, for instance by moving towards a 3GPP2 HRPD access, via an optimized handoff procedure. However, packet losses may occur upon handover.

### SUMMARY

It is therefore a broad object of this invention to provide a method and a node for supporting optimized handover of a user equipment between dissimilar networks.

A first aspect of the present invention is directed a method of supporting an optimized handover of a user equipment (UE). The method comprises a first step of receiving at a mobility management entity (MME), from a first radio access network (RAN), an attachment request for a session of the UE. Responsive thereto, the MME sends towards a gateway a request to create the session. The sent request comprises an indication that optimized handover is supported by the MME. The MME then receives from the gateway a key having been reserved for the session. Thereafter, the MME receives a handover indication for the session from a second RAN. The MME forwards the reserved key towards the second RAN.

A second aspect of the present invention is directed to a mobility management entity (MME) for supporting optimized handover of a user equipment (UE). The MME comprises a memory, a controller, and an interface configured to communicate with radio access networks (RAN) and with a gateway. The controller is configured to read and write in the memory, to control the interface and to communicate therethrough with the RANs and with the gateway. The controller further is configured to receive from a first RAN an attachment request for a session of the UE. Having received the attachment request, the controller sends towards the gateway a request to create the session, the request comprising an indication that optimized handover is supported. The controller then receives, from the gateway, a key having been reserved for the session. The controller stores the reserved key in the memory. The controller then receives, from a second RAN, a handover indication for the session. The controller reads the reserved key from the memory and forwards the reserved key towards the second RAN.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a prior art representation of an exemplary 3GPP network adapted to support a proxy mobile internet protocol;

FIG. 2 shows steps of an exemplary method of supporting optimized handover, as per some teachings of the present invention;

FIGS. 3a and 3b show a sequence diagram depicting exemplary steps of the method of the present invention; and

FIG. 4 shows an exemplary mobility management entity according to an aspect of the present invention.

### DETAILED DESCRIPTION

The innovative teachings of the present invention will be described with particular reference to various exemplary uses and aspects of the preferred embodiment. However, it should be understood that this embodiment provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the description of the figures, like numerals represent like elements of the invention.

The present invention provides a method and a node called mobility management entity (MME) to support optimized handover of a user equipment (UE) session between radio access networks (RAN) that may be dissimilar in that they may offer different radio access technologies. In the case of some of the radio access technology standards, proxy mobile internet protocol (PMIP) is the mobility protocol of choice. To support tunneling between a first network in which a session of the UE was set up and a second network in which PMIP is used, in case of an eventual handover, an uplink generic routing encapsulation (GRE) key is reserved upon session set up. Because data traffic will be exchanged between the UE and a service network accessed through a packet data gateway (PGW), the MME requests the PGW to create the session on a core network (CN) side, to complement the RAN session. The PGW is responsible for allocating the uplink GRE key while the MME generally provides mobility management for the UE session. According to the present invention, the MME requests the PGW to reserve the uplink GRE key during initial stages of the UE session setup process, for example as soon as a RAN provides the MME with an indication that a radio connection is being set up for the UE.

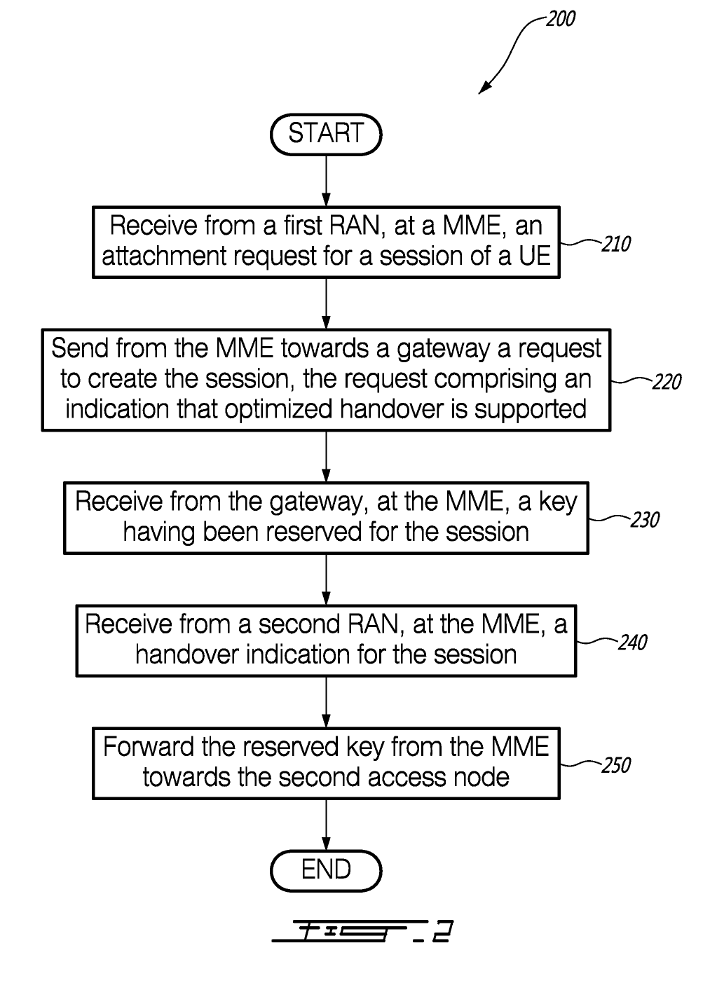

Reference is now made to the Drawings, in which FIG. 2 shows steps of an exemplary method of supporting optimized handover, as per some teachings of the present invention. A method 200 is implemented in a MME built to support some aspects the present invention. At step 210, the MME receives an attachment request for a session being set up for a UE. The request is received at the MME from a first RAN. The MME sends, at step 220, a request to create the session. The request is sent towards a gateway and comprises an indication that optimized handover is supported by the MME. The MME then receives from the gateway, at step 230, a key having been reserved for the session of the UE. At a step 240, the MME receives, from a second RAN, a handover indication for the session. In turn, the MME forwards the reserved key towards the second RAN, at step 250.

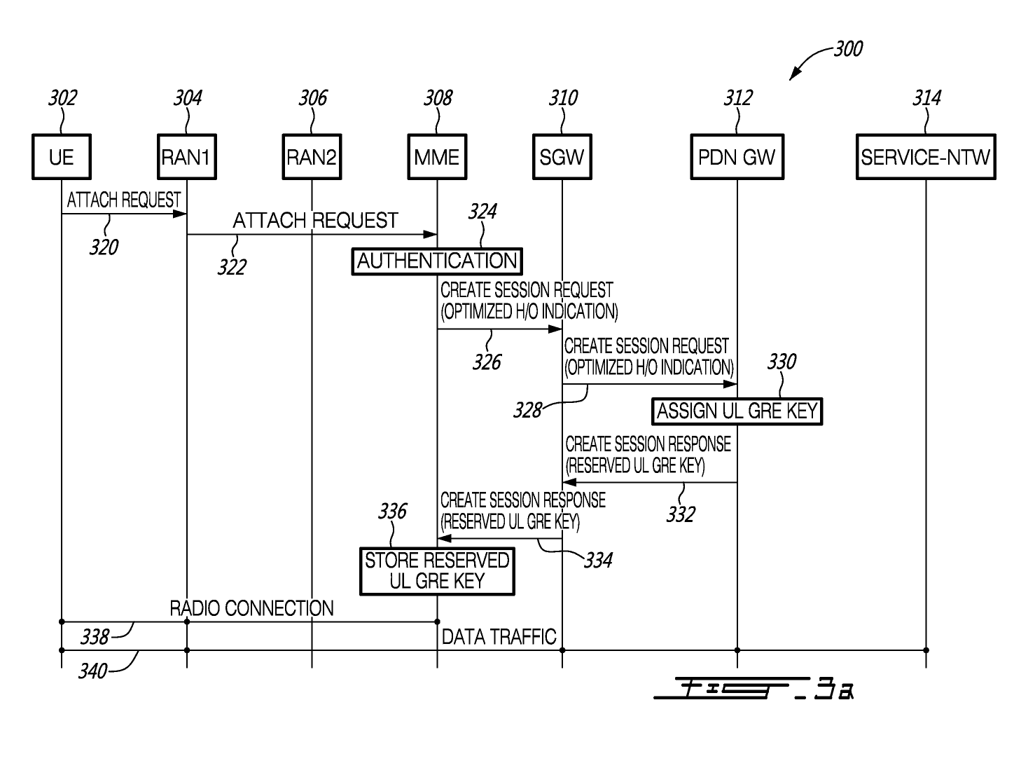

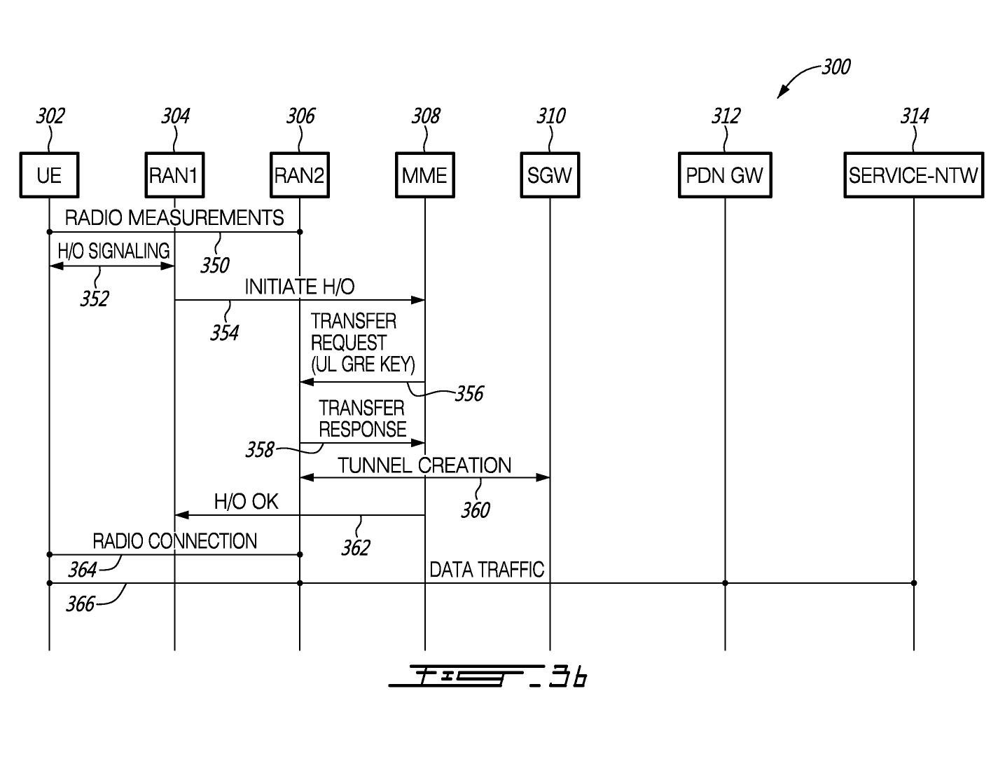

FIGS. 3a and 3b, collectively referred hereinbelow as FIG. 3, show a sequence diagram depicting exemplary steps of the method of the present invention. A sequence 300 takes place between nodes of a network that comprises a UE 302, a first RAN1 304, a second RAN2 306, a MME 308, an SGW 310, a PDN GW 312 and a service network 314. Even though elements of the network are shown as directly coupled in FIG. 3, the elements may be indirectly coupled and separated geographically. The simplified coupling is shown in order to more clearly illustrate communication paths. It should also be understood that the network may comprise a plurality of each type of gateways, a plurality of MMEs, several distinct RANs, and will generally serve a large number of UEs. Each RAN may comprise a plurality of access nodes (not shown). The network may provide UEs with access to a plurality of service networks. The network may further comprise other elements (not shown) used, example, for authenticating the UEs, or for charging purposes.

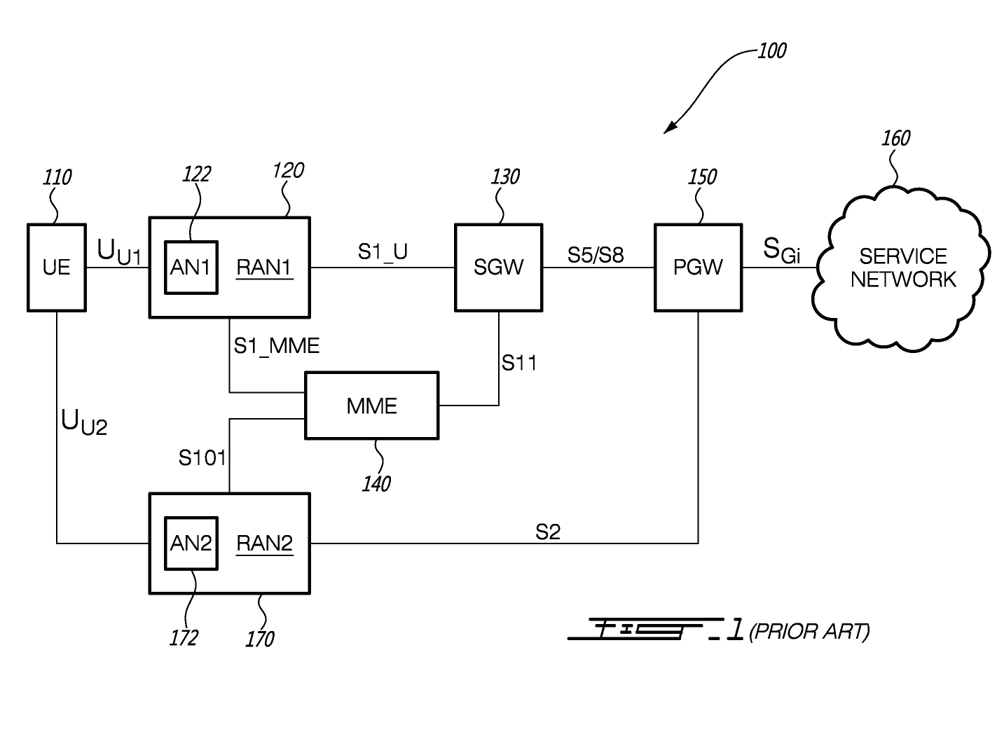

The method starts at step 320 when the UE 302 sends and attachment request message towards the RAN1 304, over an air interface. Generally, the attachment request is received at an access node (not shown on FIG. 3, but shown on FIG. 1), which may, for example, be part of a 3^{rd} generation partnership project (3GPP) network, in which case the RAN1 304 is also compliant with 3GPP specifications. The RAN1 304 forwards the content of the attachment request to the MME 308 at step 322. The attachment request as forwarded by the RAN1 304, as well as some other of the messages exchanged between the MME 308, the RANs and the gateways, may comply with a general packet radio service (GPRS) tunneling protocol (GTP). The MME 308 authenticates the UE 302 by verifying a content of the attachment request, as is well-known in the art, at step 324; step 324 may involve the MME 308 exchanging some signaling with other nodes (not shown). Once the UE 302 has been authenticated, the MME 308 sends a create session request message, which may be a GTP create session message, towards a gateway at step 326. The create session request comprises an indication that the MME 308 supports optimized handover features. The message of step 326 is intended for the PDN GW 312, but may transit through the SGW 310, which may be present in a communication path between the MME 308 and the PDN GW 312. The SGW 310 having received the message of step 326 forwards its content to the PDN GW at step 328. At step 330, the PDN GW 312 assigns a key, reserved for the session of the UE. The key may for example be an uplink GRE key. In the same step 330, the PDN GW 213 may also assign a tunnel endpoint identifier (TEID) for the session. The TEID may be used for unambiguous identification of a tunnel established between the SGW 310 and the RAN1 304. The PDN GW 312 then sends a create session response message 332, which may be a GTP create session response message and which carries the reserved key, towards the MME 308. The create session response message may further carry the TEID. The create session response message and its content may transit through the SGW 310, which forwards it to the MME 308 at step 334. The MME 308 stores the reserved key in an internal memory at step 336. Thereafter, a radio connection is set up between the UE 302 and the RAN1 304, at step 338, this step involving the MME 308 that participates in configuration of a radio bearer between the UE 302 and the RAN1 304, as is well-known in the art. Data traffic may then be exchanged between the UE 302 and the service network 314, said data traffic generally transiting through the RAN1 304, the SGW 310, and the PDN GW 312.

Because the UE 302 may be a multimode terminal, it may detect radio signals from access nodes (not shown) of the RAN2 306, despite the fact that the RAN2 306 may provide a distinct type of radio access technology when compared to the RAN1 304. The RAN2 306 may, for example, comprise a 3^{rd} generation partnership project 2 (3GPP2) technology. At step 350 which, in fact, may represent a continuous process, the UE 302 performs radio measurements on one or more access nodes (not shown) of the RAN2 306. The RAN1 304 may determine that RAN2 306 is a suitable choice for a handover of the UE 302, for example because its access nodes provide a better radio signal, because the RAN2 306 has more capacity, and the like. The UE 302 and the RAN1 304 exchange handover signaling at step 352. The RAN1 304 then sends an initiate handover message 354 to the MME 308. The MME 308 provides the reserved key to the RAN2 306 by sending thereto a transfer request message 356, which may be sent over an S101 interface established between the MME 308 and the RAN2 306. The RAN2 306 acknowledges this information by sending a transfer response message 358 to the MME 308. Following steps 360 on one hand, and 362 and 364 on the other hand, may take place in parallel or concurrently. At step 360, the RAN2 306 and the SGW 310 exchange necessary signaling to create a tunnel therebetween. This tunnel is for temporary use in forwarding downlink data towards the UE 302; this tunnel is to be released at the end of the handover process (step not shown). At step 362, the MME 308 sends a handover OK message RAN1 304. A new radio connection is established between the UE 302 and the RAN2 306 at step 364. Thereafter, data traffic continues being exchanged between the UE 302 and the service network 314, but this time passing between the RAN2 306 and the PDN GW 312.

The key, which has been reserved at step 330 and provided to the RAN2 306 at step 356, is then recognized at the PDN GW 312 for accepting the data, transmitted along with the key, received from the RAN2 306. Because the RAN2 306 has received the reserved key as early as step 356, it has been capable of using it to forward any uplink traffic received from the UE 302 before completion of handover process. As a result, packet losses are minimized and in some instances entirely avoided during the handover of the UE 302. When the RAN2 306 supports 3GPP2 specifications, it may use PMIP as a mobility protocol and the key may be the aforementioned uplink GRE key.

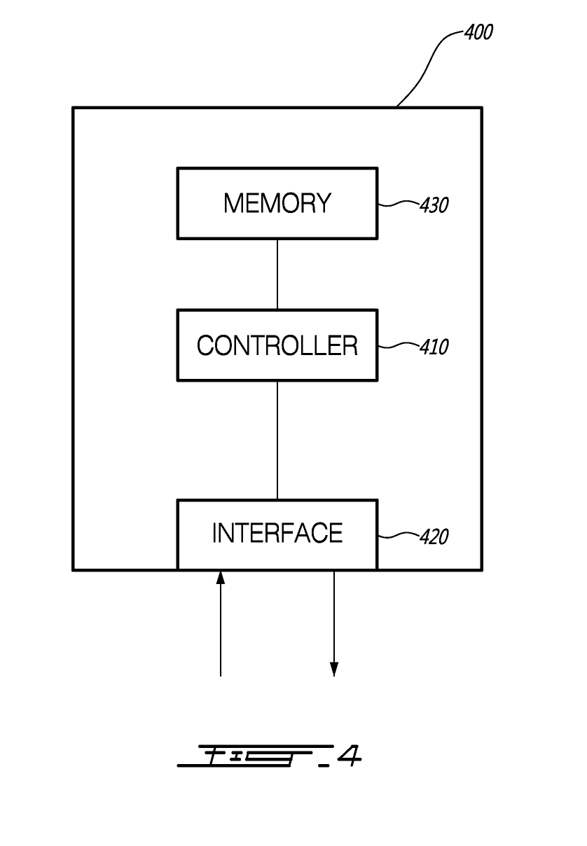

An exemplary construction of a mobility management entity will now be described by reference to FIG. 4, which shows an exemplary mobility management entity according to an aspect of the present invention. A mobility management entity (MME) 400 comprises an interface 420, a controller 410 and a memory 430. The memory 430 may be a volatile memory, or may alternatively be a non-volatile memory, or persistent memory, that can be electrically erased and reprogrammed and that may be implemented, for example, as a flash memory or as a data storage module. The controller 410 may be any commercially available, general purpose processor, or may be specifically designed for operation in the MME 400. The controller 410 may be operable to execute processes related to the present invention in addition to numerous other processes. Specifically, the controller 410 reads and writes various types of information in the memory 420. The controller 410 controls the interface 420 and communicates therethrough with other nodes of a communication network. The interface 420 may be implemented as one single device or as distinct devices for receiving and sending signaling, messages and data. The MME 400 is connected toward a plurality of RANs and gateways; means for connecting the MME 400 toward other network elements may vary as, for example, connection toward one gateway might be on an Ethernet link while connection toward a RAN might be on an asynchronous transfer mode (ATM) link. Therefore the interface 420 may comprise a plurality of devices for connecting on a plurality of links of different types. The interface 420 may support various protocols, such as for example GTP and PMIP, as well as various references points, such as for example S1_MME, S101, and S11. Only one generic interface 420 is illustrated for ease of presentation of the present invention. The MME 400 may further perform various mobility management functions and provide support for radio management functions. The MME 400 may thus comprise many more components, as is well-known in the art.

In operation, the controller 410 receives from a first RAN, which may be part of a 3GPP network, an attachment request for a session of the UE. Having received the attachment request, the controller 410 sends towards a gateway a request to create the session, the request comprising an indication that optimized handover is supported. The controller 410 then receives, from the gateway, a key having been reserved for the session. The controller 410 stores the reserved key in the memory 430. The controller 410 then receives, from a second RAN, which may comprise a 3GPP2 node, a handover indication for the session. The controller 410 reads the reserved key from the memory 430 and forwards the reserved key towards the second RAN.

In addition to the features described in relation to FIG. 4, the MME 400 may be capable of performing the features of the various embodiments of the MME presented in FIGS. 2 and 3.

Although several aspects of the preferred embodiment of the method, and of the mobility management entity of the present invention have been illustrated in the accompanying Drawings and described in the foregoing Detailed Description, it will be understood that the invention is not limited to the embodiments disclosed, but is capable of numerous rearrangements, modifications and substitutions without departing from the teachings of the invention as set forth and defined by the following claims.

1. A method of supporting optimized handover of a user equipment (UE), the method comprising the steps of:
receiving at a mobility management entity (MME), from a first radio access network (RAN), an attachment request for a session of the UE;
sending from the MME, towards a gateway, a request to create the session, the request comprising an indication that optimized handover is supported;
receiving at the MME, from the gateway, a key having been reserved for the session;
receiving at the MME, from a second RAN, a handover indication for the session; and
forwarding the reserved key from the MME towards the second RAN.

2. The method of claim 1, wherein:
the key is an uplink generic routing encapsulation (GRE) key.

3. The method of claim 1, wherein:
the gateway is a packet data network gateway (PDN GW).

4. The method of claim 2, wherein:
a serving gateway (SGW) is in a communication path between the MME and the PDN GW;
the request to create the session sent from the MME towards the PDN GW transits through the SGW; and
the reserved key received at the MME from the PDN GW transits through the SGW.

5. The method of claim 1, wherein:
the MME, the gateway and the first RAN communicate by use of a general packet radio service tunneling protocol (GTP);
the request to create the session is a GTP create session message; and
the reserved key is part of a GTP create session response message.

6. The method of claim 1, wherein:
the first RAN and the second RAN are part of dissimilar access networks.

7. The method of claim 6, wherein:
the first RAN is part of a 3^{rd} generation partnership project (3GPP) network.
the second RAN comprises a 3^{rd} generation partnership project 2 (3GPP2) node; and
the MME communicates with the second RAN over a S101 interface.

8. The method of claim 1, wherein:
the step of receiving at the MME the reserved key further comprises receiving a tunnel endpoint identifier for the session.

9. A mobility management entity for supporting optimized handover of a user equipment (UE), comprising:
a memory;
an interface configured to communicate with radio access networks (RAN) and with a gateway; and
a controller configured to read and write in the memory, to control the interface and to communicate therethrough with the RANs and with the gateway, the controller further configured to:
receive from a first RAN an attachment request for a session of the UE;
send towards the gateway a request to create the session, the request comprising an indication that optimized handover is supported;
receive, from the gateway, a key having been reserved for the session;
store the reserved key in the memory;
receive, from a second RAN, a handover indication for the session;
read the reserved key from the memory; and
forward the reserved key towards the second RAN.

10. The mobility management entity of claim 9, wherein:
the first RAN is part of a 3^{rd} generation partnership project (3GPP) network.
the second RAN comprises a 3^{rd} generation partnership project 2 (3GPP2) node; and
the interface is an S101 interface for communicating with the 3GPP2 node.

11. The mobility management entity of claim 9, wherein:
the interface communicates with at least one of the RANs and with the gateway by use of a general packet radio service tunneling protocol (GTP);
the request to create the session is a GTP create session message; and
the reserved key is part of a GTP create session response message.
